(19) United States
(12) Patent Application Publication
(10) Pub. No.: US 2004/0042579 A1
(43) Pub. Date: Mar. 4, 2004

(54) Nuclear power plant and method of operating the same

(76) Inventors: Roland Leslie John Bolton, Kempton Park (ZA); Petrus Daniel Kemp, Pretoria (ZA); Willem Adriaan Odendaal Kriel, Centurion (ZA); David Richard Nicholls, Midrand (ZA); Michael Christiaan Nieuwoudt, Centurion (ZA)

Correspondence Address: KLARQUIST SPARKMAN, LLP, 121 SW SALMON STREET, SUITE 1600, PORTLAND, OR, 97204, US

(21) Appl. No.: 10/450,021

(22) PCT Filed: Mar. 25, 2002
(86) PCT No.: PCT/IB02/00887

(30) Foreign Application Priority Data
Mar. 26, 2001 (ZA) 01/2459
Apr. 9, 2001 (ZA) 01/2915

(51) Int. Cl. G21C 3/56; G21C 19/28

(52) U.S. Cl. 376/383

(57) ABSTRACT

A method of regulating the power generated in a nuclear power plant which includes the step of regulating the flow of helium through the reactor. To this end, the power plant includes a closed loop power generation circuit having at least one compressor and a recirculation circuit whereby helium can be recirculated around the compressor. By regulating the flow of helium around the recirculation circuit using suitable valves the flow of helium through the reactor and hence the power generated can be regulated. The plant includes a helium inventory control system whereby the inventory of helium in the power generation circuit can be varied thereby varying the power generated in the circuit.

This invention relates to the generation of electricity. More particularly it relates to a nuclear power plant. It also relates to a method of regulating the power generated by the plant.

According to one aspect of the invention there is provided a nuclear power plant which includes

a closed loop power generation circuit making use of helium as a working fluid and having at least one compressor;

a recirculation circuit whereby helium can be recirculated around the compressor; and

valve means for regulating the flow of helium in the recirculation circuit.

The power generation circuit may include

a nuclear reactor;

a low pressure compressor;

a high pressure compressor;

drive means for driving the low pressure compressor and the high pressure compressor;

a pre-cooler positioned upstream of the low pressure compressor;

an inter-cooler positioned between the low pressure compressor and the high pressure compressor;

a low pressure recirculation circuit for recirculating helium around the low pressure compressor;

a high pressure recirculation circuit for recirculating helium around the high pressure compressor; and

valve means for regulating the flow of helium in each of the recirculation circuits.

According to another aspect of the invention in a nuclear power plant having a closed loop power generation circuit which uses helium as the working fluid and which has a nuclear reactor, there is provided a method of regulating the power generated by the plant, which includes the step of regulating the flow of helium through the reactor.

When the nuclear power plant is a nuclear power plant as described above, regulating the flow of helium through the reactor may include regulating the flow of helium in the or each recirculation circuit.

The drive means may include, arranged in series, a high pressure turbine, a low pressure turbine and a power turbine drivingly connected, respectively, to the high pressure compressor, the low pressure compressor and an electrical generator, the power generation circuit further including a recuperator having a low pressure side connected between the power turbine and the pre-cooler, and a high pressure side connected between the high pressure compressor and the nuclear reactor, the high pressure recirculation circuit including a high pressure recirculation line in which a recirculation valve is mounted the high pressure recirculation line extending from a point between the high pressure compressor and the high pressure side of the recuperator to a point between the low pressure compressor and the intercooler and the low pressure recirculation circuit including a low pressure recirculation line in which a recirculation valve is mounted, the low pressure recirculation line extending from a point between the low pressure compressor and the intercooler to a point between the recuperator and the pre-cooler.

Regulating the flow of helium in the recirculation circuits, may include controlling the operation of the recirculation valves to regulate the flow of helium in the recirculation circuits.

Regulating the flow of helium through the reactor may include adjusting the helium inventory in the power generation circuit.

To this end the nuclear plant may include a helium inventory control system which is selectively connectable in flow communication with the power generation circuit to permit helium to be introduced into or removed from the power generation circuit.

Adjusting the helium inventory may include connecting the helium inventory control system in flow communication with the power generation circuit selectively to increase or decrease the helium inventory in the power generation circuit and thereby increase or decrease the power generated as required.

The driving force for the transfer of helium between the helium inventory control system and the power generation circuit may be the pressure difference between the helium inventory control system and the power generation circuit.

The helium inventory control system may include a plurality of storage tanks, the pressure in which varies from a low pressure tank to a high pressure tank.

The helium inventory control system may be selectively connectable to the power generation circuit at a relatively high pressure point and a relatively low pressure point of the power generation circuit.

The high pressure point may be downstream of the high pressure compressor.

The low pressure point may be upstream of the low pressure compressor between the low pressure compressor and the power turbine.

In one embodiment of the invention, when the plant is in load following mode and it is desired to increase the power generated, the method may include the step of introducing helium from the helium inventory control system into the power generation circuit.

In this embodiment, helium may be introduced from the helium inventory control system into the power generation circuit at a low pressure point of the power generation circuit. Similarly, helium will typically be extracted from the power generation circuit at a high pressure point and fed to the helium inventory control system.

Helium extracted from the power generation circuit is dumped into the storage tank with the highest pressure which has capacity to accommodate the helium. Helium fed from the helium inventory control system to the power generation circuit is taken from the tank with the lowest pressure and which has capacity to supply the helium.

One problem associated with this arrangement is that when, in load following mode, the introduction of helium into the power generation circuit at a low pressure point in response to a request for a power increase, results in a non-minimum phase response of power, which actually results in a dip in the power generated which can be undesirable.

The method may accordingly include introducing helium into the power generation circuit at a low pressure point of the power generation circuit and compensating for a non-minimum phase response by regulating the flow of helium in the or each recirculation circuit.

Although this arrangement results in an overall decrease in the efficiency of the power generation circuit, it permits the power generated by the power generation circuit to be increased in a manner which avoids the non-minimum phase response of power.

In another embodiment of the invention, increasing the power generated when the plant is in load following mode may include introducing helium into the power generation circuit at the high pressure point in the power generating circuit.

The high pressure point of the power generation circuit is typically between the compressor and the reactor and introduction of helium at this point avoids the non-minimum phase response and hence the dip in power.

In this embodiment the method may include, if necessary, regulating the flow of helium through the or each recirculation circuit to avoid a non-minimum phase response.

To this end, the helium inventory control system may include at least one booster tank in which helium is stored at a pressure higher than that of the maximum pressure in the power generation circuit and from which helium can be fed into the power generation circuit at the high pressure point.

The helium inventory control system may include a compressor arrangement for feeding helium to the at least one booster tank at the desired pressure.

The method may include, as the pressure in the booster tank decreases, feeding helium into the power generation circuit from the helium inventory control system at a low pressure point in the power generation circuit and feeding at least some of the helium exiting the compressor to an upstream side of the compressor so that a portion of the helium circulates around the compressor.

Under load following conditions when a portion of the helium in the power generator is recirculated in the or each recirculation circuit,increasing the power generated may include the step of reducing the volume of helium flowing through the or each recirculation circuit.

The plant may include a variable resistor bank which is electrically disconnectably connectable to the generator.

The plant may include a recuperator bypass line which extends from a position upstream of the high pressure side of the recuperator to a position downstream of the high pressure side of the recuperator and a recuperator bypass valve mounted in the recuperator bypass line to regulate the flow of helium therethrough.

The plant may include a gas bypass line in which a gas bypass valve is provided to regulate the flow of helium therethrough, the gas bypass line extending from a position upstream of the high pressure side of the recuperator to a position upstream of the pre-cooler.

In the event of loss of load, the method may include the steps of,

opening the high pressure recirculation valve, the low pressure recirculation valve and the gas bypass valve;

closing the gas bypass valve; and

regulating the operation of the high pressure bypass valve and the low pressure bypass valve to stabilize the power generation circuit.

Typically, when the valves are opened they are displaced to their fully open position.

The gas bypass valve may be opened immediately after the loss of load event is detected and closed after a predetermined time has elapsed.

The method may include, after the process stabilizes, activating the helium inventory control system to bring the plant into a stable, low power operation mode.

The plant may include a variable resistor bank which is disconnectably connectable to the generator, the method including controlling the speed of the power turbine by regulating the load on the generator via the resistor bank.

Introducing helium into the power generation circuit at the high pressure point can be used both when in load following mode, to step-up the power generated and when rapid increases of generated power are required.

When a power step-down is required the method may include the step of opening at least one of the recirculation valves.

Preferably, the method includes opening both of the high pressure and low pressure recirculation valves.

When the plant includes a variable resistor bank which is disconnectably connectable to the generator, the method may include using the variable resistor to compensate for small changes in the power demand. This arrangement avoids unnecessary wear of the valves.

The invention will now be described, by way of example, with reference to the accompanying diagrammatic drawings.

In the drawings,

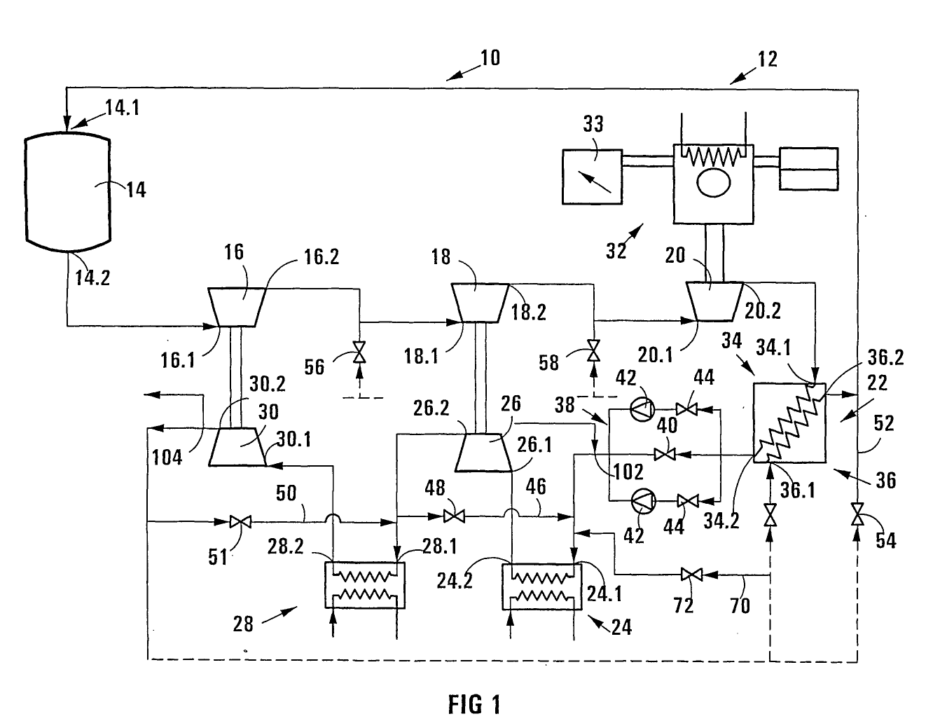

FIG. 1 shows a schematic representation of part of a nuclear power plant in accordance with the invention; and

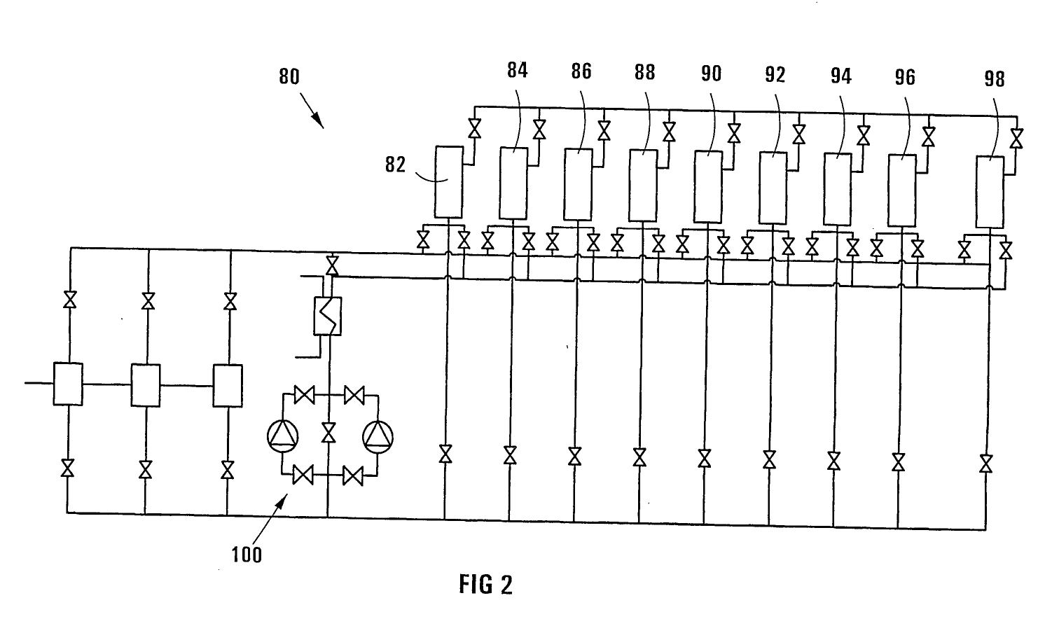

FIG. 2 shows a schematic representation of a helium inventory control system forming part of the nuclear power plant in accordance with the invention.

With reference, particularly to FIG. 1 of the drawings, reference numeral 10 refers generally to part of a nuclear plant in accordance with the invention. The nuclear power plant 10 includes a closed loop power generation circuit, generally indicated by reference numeral 12. The power generation circuit 12 includes a nuclear reactor 14, a high pressure turbine 16, a low pressure turbine 18, a power turbine 20, a recuperator 22, a pre-cooler 24, a low pressure compressor 26, an intercooler 28 and a high pressure compressor 30.

The reactor 14 is a pebble bed reactor making use of spherical fuel elements. The reactor 14 has a working fluid inlet 14.1 and a working fluid outlet 14.2.

The high pressure turbine 16 is drivingly connected to the high pressure compressor 30 and has an upstream side or inlet 16.1 and a downstream side or outlet 16.2, the. inlet 16.1 being connected to the outlet 14.2 of the reactor 14.

The low pressure turbine 18 is drivingly connected to the low pressure compressor 26 and has an upstream side or inlet 18.1 and a downstream side or outlet 18.2. The inlet 18.1 is connected to the outlet 16.2 of the high pressure turbine 16.

The nuclear power plant 10 includes a generator, generally indicated by reference numeral 32 to which the power turbine 20 is drivingly connected. The power turbine 20 includes an upstream side or inlet 20.1 and a downstream side or outlet 20.2. The inlet 20.1 of the power turbine 20 is connected to the outlet 18.2 of the low pressure turbine 18. The plant 10 includes a variable resistor bank 33 which is electrically disconnectably connectable to the generator 32.

The recuperator 22 has a hot or low pressure side 34 and a cold or high pressure side 36. The low pressure side of the recuperator 34 has an inlet 34.1 and an outlet 34.2. The inlet 34.1 of the low pressure side is connected to the outlet 20.2 of the power turbine 20.

The pre-cooler 24 is a helium to water heat exchanger and includes a helium inlet 24.1 and a helium outlet 24.2. The inlet 24.1 of the pre-cooler 24 is connected to the outlet 34.2 of the low pressure side 34 of the recuperator 22.

The low pressure compressor 26 has an upstream side or inlet 26.1 and a downstream side or outlet 26.2. The inlet 26.1 of the low pressure compressor 26 is connected to the helium outlet 24.2 of the pre-cooler 24.

The inter-cooler 28 is a helium to water heat exchanger and includes a helium inlet 28.1 and a helium outlet 28.2. The helium inlet 28.1 is connected to the outlet 26.2 of the low pressure compressor 26.

The high pressure compressor 30 includes an upstream side or inlet 30.1 and a downstream side or outlet 30.2. The inlet 30.1 of the high pressure compressor 30 is connected to the helium outlet 28.2 of the inter-cooler 28. The outlet 30.2 of the high pressure compressor 30 is connected to an inlet 36.1 of the high pressure side of the recuperator 22. An outlet 36.2 of the high pressure side of the recuperator 22 is connected to the inlet 1 4.1 of the reactor 14.

The nuclear power plant 10 includes a start-up blower system 5 generally indicated by reference numeral 38 connected between the outlet 34.2 of the low pressure side 34 of the recuperator 22 and the inlet 24.1 of the pre-cooler 24.

The start-up blower system 38 includes a normally open start-up blower system in-line valve 40 which is connected in-line between the outlet 34.2 of the low pressure side of the recuperator and the inlet 24.1 of the pre-cooler 24. Two blowers 42 are connected in parallel with the start-up blower system in-line valve 40 and a normally closed isolation valve 44 is associated with and connected in series with each blower 42.

A low pressure compressor recirculation line 46 extends from a position between the outlet or downstream side 26.2 of the low pressure compressor 26 and the inlet 28.1 of the inter-cooler 28 to a position between the start-up blower system 38 and the inlet 24.1 of the pre-cooler 24. A low pressure recirculation valve 48 is mounted in the low pressure compressor recirculation line 46.

A high pressure compressor recirculation line 50 extends from a position between the outlet or downstream side 30.2 of the high pressure compressor and the inlet 36.1 of the high pressure side 36 of the recuperator 22 to a position between the outlet or downstream side 26.2 of the low pressure compressor 26 and the inlet 28.1 of the inter-cooler 28. A high pressure recirculation valve 51 is mounted in the high pressure recirculation line 50.

A recuperator bypass line 52 extends from a position upstream of the inlet 36.1 of the high pressure side 36 of the recuperator 22 to a position downstream of the outlet 36.2 of the high pressure side 36 of the recuperator 22. A normally closed recuperator bypass valve 54 is mounted in the recuperator bypass line 52.

The plant 10 includes a high pressure coolant valve 56 and a low pressure coolant valve 58. The high pressure coolant valve 56 is configured, when open, to provide a bypass of helium from the high pressure side or outlet 30.2 of the high pressure compressor 30 to the inlet or low pressure side 18.1 of the low pressure turbine 18. The low pressure coolant valve 58 is configured, when open, to provide a bypass of helium from the high pressure side or outlet 30.2 of the high pressure compressor 30 to the inlet 20.1 of the power turbine 20.

The plant 10 includes a gas bypass line 70 in which a gas bypass valve 72 is provided to regulate the flow of helium therethrough. The gas bypass line 70 extends from a position upstream of the inlet 36.1 of the high pressure side of the recuperator 22 to a position upstream of the inlet 24.1 of the pre-cooler 24.

Referring now to FIG. 2 of the drawings, the nuclear power plant 10 further includes a helium inventory control system, generally indicated by reference numeral 80. The helium inventory control system 80 includes eight storage tanks 82, 84, 86, 88, 90, 92, 94, 96 and a booster tank 98.

The pressure in the storage tanks 82 to 96 varies from a high pressure tank 96 to a low pressure tank 82. The pressure of helium within the booster tank 98 is higher than that within the power generation circuit 12. To this end, a compressor arrangement, generally indicated by reference numeral 100 is provided to feed helium at a sufficiently high pressure to the booster tank 98 and/or storage tanks 82 to 96. The helium inventory control system 80 is selectively connectable to the power generation circuit to permit the flow of helium therebetween at a low pressure point 102 and a high pressure point 104 (FIG. 1).

In use, it is necessary that the power output of the nuclear power plant can be adjusted continuously to the power demand or requirement. As described in more detail herebelow, the helium inventory control system can be used to increase and reduce the power generated in the nuclear power plant.

When in load following mode, the generator output is adjusted to the power demand of the grid to which the plant is connected at all times. Typically this will require that the plant be capable of following a sequence of from 100% to 40% to 100% of the maximum continuous power rating without any external compressor. The rate of increase or decrease will typically not exceed 10% of the maximum continuous power rating per minute.

In order to decrease the power generated, helium is extracted from the power generation circuit 12 at the high pressure point and dumped into the storage tank with the highest pressure and spare capacity for receiving the helium.

Several options are available to increase the power generated.

One option includes feeding helium from the helium inventory control system to the power generation circuit at the low pressure point after a request for a power increase. Although this will eventually lead to an increase in power, initially it results in a non-minimum phase response of the power, which results in a dip in the power generated. This dip disturbs the smooth control of the power output of the system.

A second option of increasing the power which avoids the non-minimum phase response of the low pressure injection is by compensating with the compressor recirculation valves 48, 51. This will require that the recirculation valves 48, 51 are, under normal circumstances, partially open when the nuclear power plant is in load following mode. If the grid requires a power increase, helium is injected from the helium inventory control system 80 to the power generation circuit at the low pressure point. Simultaneously, one or both of the recirculation valves 48, 51 is displaced towards its closed condition which results in an accurately controlled increase in the power generated. The advantage with this arrangement is that the response does not show the non-minimum phase response behaviour and the power increase is easy to control. A disadvantage with this arrangement is that it is necessary to operate the nuclear power plant with the recirculation valves 48, 51 partially open so that there is reserve power to cancel the non-minimum phase effect of low pressure injection. Running the nuclear power plant with the compressor recirculation valves 48, 51, partially open, will decrease the overall efficiency of the plant.

A third option of increasing the power which avoids the non-minimum phase response of the low pressure injection is by compensating for the non-minimum phase response by the simultaneous injection of helium at the high pressure point.

A fourth option to increase the power generated in load following mode, is to feed helium from the booster tank 98 of the helium inventory control system 80 to the power generation circuit 12 at the high pressure point of the power generation circuit. This leads to an increase in the power generated without the non-minimum phase response behaviour. As the pressure in the booster tank 98 decreases, additional power is required, the compressor recirculation valves 48, 51 will open in order to permit the power generated to be increased by closing the valves 48, 51 in the manner described above and thereby avoiding the non-minimum phase response. This process can be optimised in a way that the amount of recirculation around the compressors is at a minimum thereby maximising the efficiency of the power generation plant.

In the event of loss of load, it is important that the speed of the power turbine 20 and the generator 32 not exceed a predetermined maximum speed. In addition, it is preferred that the Brayton cycle remains functioning at very low load conditions, referred to as house load. This process to keep the energy conversion cycle running at house load conditions is called “load rejection”.

In the case of loss of load the low pressure recirculation valve 48, high pressure recirculation valve 51 and the gas recirculation valve 72 are fully opened. A predetermined time period after the initiating event, the gas bypass valve 72 is closed and the high pressure recirculation valve 51 and low pressure recirculation valve 48 are displaced towards their closed conditions. After the process stabilizes, the helium inventory control system 80 is activated to bring the plant into a stable, low power operation mode and the low pressure recirculation valve 48 and high pressure recirculation valve 51 may be closed if required.

The resistor bank 33, as part of a power turbine speed controller, may be used to control the speed of the power turbine.

The plant 10 is typically configured to make use of a modified Brayton cycle as the thermodynamic conversion cycle. In the event of an emergency stop of the Brayton cycle, only the gas bypass valve 72 is opened and remains open until the Brayton cycle stops.

In existing power plants of which the Inventor is aware, the load rejection process and also an emergency stop is achieved by bypassing the turbines for at least part of the working fluid. In the present application, however, this solution would result in the introduction of high pressure (of the order of 85 bar) and high temperature (of the order of 900° C.) control valves which are potentially expensive and unreliable. In contrast, with the present invention, load rejection is achieved by operating the valves 48, 51, 72 which operate at a significantly lower temperature.

When it is desired to step up the power produced by the plant 10 more rapidly than in the load following mode, use can be made of the booster tank to inject helium into the power generation circuit at the high pressure point. Typically, the volume of the booster tank will be selected to permit the power to be stepped up at a rate of at least 20% of the maximum continuous rating per minute for a period of at least 30 seconds and an occurrence frequency of less than once per hour.

To this end, when the power plant has a reactor outlet pressure of approximately 85 bar and a power capacity of approximately 128 MW, the booster tank 98 will typically have a volume of approximately 100 m³ and the helium will be stored at a pressure of approximately 100 bar.

As mentioned above, in order to reduce the power generated by the plant 10, helium can be extracted from the power generation circuit and fed to the helium inventory control system. Although this adequately permits the power to be reduced when in load following mode, when it is required for a power step down the process is too slow. Accordingly, in order to have a power step-down, one or both of the recirculation valves 48, 51 is opened which results in the mass flow of helium through the reactor 14 decreasing and less power is transferred to the helium. This in turn results in less power being generated in the power turbine. Typically, the plant is capable of operating with a power step down of at least 20% of the maximum continuous rating per minute decrease for a duration of 30 seconds and an occurrence frequency of less than once per hour.

The Inventors believe that a nuclear power plant in accordance with the invention will permit close control of the power generated by the nuclear power plant.

1. A nuclear power plant which includes
a closed loop power generation circuit making use of helium as a working fluid and having at least one compressor;
a recirculation circuit whereby helium can be recirculated around the compressor; and
valve means for regulating the flow of helium in the recirculation circuit.

2. A plant as claimed in claim 1, in which the power generation circuit includes
a nuclear reactor;
a low pressure compressor;
a high pressure compressor;
drive means for driving the low pressure compressor and the high pressure compressor;
pre-cooler positioned upstream of the low pressure compressor;
an inter-cooler positioned between the low pressure compressor and the high pressure compressor;
a low pressure recirculation circuit for recirculating helium around the low pressure compressor;
a high pressure recirculation circuit for recirculating helium around the high pressure compressor; and
valve means for regulating the flow of helium in each of the recirculation circuits.

3. A plant as claimed in claim 2, in which the drive means includes, arranged in series, a high pressure turbine, a low pressure turbine and a power turbine drivingly connected, respectively, to the high pressure compressor, the low pressure compressor and an electrical generator, the power generation circuit further including a recuperator having a low pressure side connected between the power turbine and the pre-cooler, and a high pressure side connected between the high pressure compressor and the nuclear reactor, the high pressure recirculation circuit including a high pressure recirculation line in which a recirculation valve is mounted, the high pressure recirculation line extending from a point between the high pressure compressor and the high pressure side of the recuperator to a point between the low pressure compressor and the intercooler and the low pressure recirculation circuit including a low pressure recirculation line in which a recirculation valve is mounted, the low pressure recirculation line extending from a point between the low pressure compressor and the intercooler to a point between the recuperator and the pre-cooler.

4. A plant as claimed in claim 3, which includes a variable resistor bank which is electrically disconnectably connectable to the generator.

5. A plant as claimed in claim 3 or claim 4, which includes a recuperator bypass line which extends from a position upstream of the high pressure side of the recuperator to a position downstream of the high pressure side of the recuperator and a recuperator bypass valve mounted in the recuperator bypass line to regulate the flow of helium therethrough.

6. A plant as claimed in any one of claims 3 to 5, inclusive, which includes a gas bypass line in which a gas bypass valve is provided to regulate the flow of helium therethrough, the gas bypass line extending from a position upstream of the high pressure side of the recuperator to a position upstream of the pre-cooler.

7. A plant as claimed in any one of claims 3 to 6 inclusive, which includes a helium inventory control system which is selectively connectable in flow communication with the power generation circuit to permit helium to be introduced into or removed from the power generation circuit.

8. A plant as claimed in claim 7, in which the helium inventory control system includes a plurality of storage tanks, the pressure in which varies from a low pressure tank to a high pressure tank.

9. A plant as claimed in claim 8, in which the helium inventory control system is selectively connectable to the power generation circuit at a high pressure point and a low pressure point of the power generation circuit.

10. A plant as claimed in claim 9, in which the high pressure point is downstream of the high pressure compressor.

11. A plant as claimed in claim 9 or claim 10, in which the low pressure point is upstream of the low pressure compressor between the low pressure compressor and the power turbine.

12. A plant as claimed in any one of claims 9 to 11, inclusive, in which the helium inventory control system includes at least one booster tank in which helium is contained at a pressure which is higher than the pressure of helium at the high pressure point of the power generation circuit.

13. A plant as claimed in claim 12, in which the helium inventory control system includes a compressor arrangement for feeding helium to the at least one booster tank at the desired pressure.

14. In a nuclear power plant having a closed loop power generation circuit which uses helium as the working fluid and which has a nuclear reactor, there is provided a method of regulating the power generated by the plant, which includes the step of regulating the flow of helium through the reactor.

15. A method as claimed in claim 14, in which when the nuclear power plant is a nuclear power plant as claimed in any one of claims 2 to 13, inclusive, regulating the flow of helium through the reactor includes regulating the flow of helium in the or each recirculation circuit.

16. A method as claimed in claim 15, in which regulating the flow of helium in the recirculation circuits, includes controlling the operation of the recirculation valves to regulate the flow of helium in the recirculation circuits.

17. A method as claimed in any one of claims 15 to 16, inclusive, in which regulating the flow of helium through the reactor includes adjusting the helium inventory in the power generation circuit.

18. A method as claimed in claim 17, in which adjusting the helium inventory includes connecting a helium inventory control system in flow communication with the power generation circuit selectively to increase or decrease the helium inventory in the power generation circuit as required.

19. A method as claimed in claim 18, in which the driving force for the transfer of helium between the helium inventory control system and the power generation circuit is the pressure difference between the helium inventory control system and the power generation circuit.

20. A method as claimed in claim 18 or claim 19 which, when the plant is in load following mode and it is desired to increase the power generated, includes the step of introducing helium from the helium inventory control system into the power generation circuit.

21. A method as claimed in claim 20, which includes introducing helium into the power generation circuit at a low pressure point of the power generation circuit and compensating for a non-minimum phase response by regulating the flow of helium in the or each recirculation circuit.

22. A method as claimed in claim 20, which includes introducing helium into the power generation circuit at a high pressure point.

23. A method as claimed in claim 22, which includes if necessary regulating the flow of helium through the or each recirculation circuit to avoid a non-minimum phase response.

24. A method as claimed in any one of claims 15 to 23, inclusive, in which under load following conditions when a portion of the helium in the power generator is recirculated in the or each recirculation circuit, increasing the power generated includes the step of reducing the volume of helium flowing through the or each recirculation circuit.

25. A method as claimed in any one of claims 15 to 19, inclusive, which, in the event of loss of load, includes the steps of,
opening the high pressure recirculation valve, the low pressure recirculation valve and the gas bypass valve;
closing the gas bypass valve; and
regulating the operation of the high pressure bypass valve and the low pressure bypass valve to stabilize the power generation circuit.

26. A method as claimed in claim 25, in which, when the valves are opened they are displaced to their fully open position.

27. A method as claimed in claim 25 or claim 26, in which the gas bypass valve is opened immediately after the loss of load event is detected and closed after a predetermined time has elapsed.

28. A method as claimed in claim 27, which includes, after the process stabilizes, activating the helium inventory control system to bring the plant in a stable, low power operation mode.

29. A method as claimed in claim 28, in which when the plant includes a variable resistor bank which is disconnectably connectable to a generator, the method includes controlling the speed of the power turbine by regulating the load on the generator via the resistor bank.

30. A method as claimed in any one of claims 15 to 19, inclusive, which includes, when a power step-down is required, opening at least one of the recirculation valves.

31. A method as claimed in claim 30, which includes opening both of the recirculation valves.

32. A method as claimed in any one of claims 14 to 31, inclusive, in which when the plant includes a variable resistor bank which is disconnectably connectable to a generator, includes the step of using the variable resistor to compensate for small changes in power demand.

33. A plant as claimed in claim 1 substantially as described herein.

34. A method as claimed in claim 14 substantially as described herein.

35. A new plant or method substantially as described and illustrated herein.
